(19) United States
(12) Patent Application Publication
(10) Pub. No.: US 2002/0117028 A1
(43) Pub. Date: Aug. 29, 2002

(54) Hand-held power tool

(75) Inventor: Masahiko Kusama, Wentzville, MO (US)

Correspondence Address: SENNIGER POWERS LEAVITT AND ROEDEL, ONE METROPOLITAN SQUARE, 16TH FLOOR, ST LOUIS, MO, 63102, US

(73) Assignee: S.P. Air Kabusiki Kaisha

(21) Appl. No.: 10/052,934

(22) Filed: Oct. 19, 2001

Related U.S. Application Data
(63) Continuation-in-part of application No. 09/731,400, filed on Dec. 6, 2000, now abandoned.

(51) Int. Cl. B25B 13/46

(52) U.S. Cl. 81/57.39

(57) ABSTRACT

A hand-held power tool includes a housing having spaced front and back walls, and an output shaft mounted in the housing for rotation in one direction or the other on an axis extending transversely with respect to the walls. The shaft has an outer end portion projecting out from the front wall for reception of an attachment for the tool. A ratchet wheel on the shaft in the space between the walls is adapted to be driven in one direction or the other for rotating the shaft in the one direction or the other. The ratchet wheel has a side face facing a fixed surface on one of the walls and a plurality of recesses extending inward from the side face spaced at intervals around the axis. Cylindrical pins are each engaged by a corresponding one of a plurality of coil compression springs for biasing the pin outward from the recess against said fixed surface for holding the ratchet wheel against rotation in a direction opposite the driven direction of rotation. The outer ends of the pins functionally engage the fixed surface.

### BACKGROUND OF THE INVENTION

This invention relates generally to hand-held power tools, more particularly to a hand-held pneumatically powered tool having an output shaft and a reversible ratchet wheel drive therfor.

The invention is especially concerned with a hand-held pneumatically powered tool primarily of the type disclosed in U.S. Pat. No. 5,535,646 dated Jul. 16, 1996 entitled Ratchet Drive, also of the type disclosed in the coassigned U.S. Pat. No. 6,158,528 dated Dec. 12, 2000, entitled Hand-Held Pneumatic Rotary Drive Device, and in the coassigned copending application of Apr. 20, 2000, Ser. No. 09/553,921, entitled Hand-Held Power Tool, all these being incorporated herein by reference.

Referring to said U.S. Pat. No. 5,535,646 (briefly the '646 patent), the tool disclosed therein is shown to include an arrangement of washers including a friction washer (numbered 36) and one or preferably two Belleville spring washers (numbered 38) which combination, as stated in lines 58-60 of column 3 of the specification of the patent, “serves to pre-load the drive gear axially and prevent oscillation thereof.” The primary purpose of this arrangement of washers is to inhibit uncalled-for rotation of the “drive gear” numbered 22 (the ratchet wheel), such as retrograde rotation thereof when the tool is set for driving the ratchet wheel in one or the other direction, as may be caused by back-drag of the pawl which has been selected for driving the ratchet wheel. Such retrograde rotation has the effect of detracting from the power of the tool. In this regard it may be observed that since in the use of the tool the ratchet wheel may be driven forward in one direction by the one pawl and forward in the other direction by the other pawl it is not possible to use means such as a back-check pawl for positively preventing retrogressive rotation of the ratchet wheel. While the '646 patent arrangement of washers has been generally satisfactory for the purpose, it has encountered the problem of relatively short life due to washer wear and the consequent necessity for shimming up the arrangement or replacing washers.

One attempt to solve the problem if rapid wear is shown in U.S. Pat. No. 4,722,252. The Belleville washer is replaced by coil springs received in holes in the ratchet wheel which bias ball bearings against a wear washer. An advantage is that the ball bears can be of a hardness similar to that of the wear washer. However because the ball bearings engage the wear washer substantially at a point, the ball bearings act like cutters as the tool operates, damaging the wear washer and reducing service life. Still another solution may be found in U.S. Pat. No. 5,896,789, in which the ball bearings are eliminated at the springs directly engage a wear washer. To work, the ends of the springs must be machined flat, which adds cost to production. However, the surface area of engagement between the springs and washer is still very small. Moreover, it is difficult to economically use springs which are sufficiently hard for wear purposes, but retain the needed resiliency.

### BRIEF SUMMARY OF THE INVENTION

Accordingly, among the several objects of this invention may be noted the provision of a tool having the reversible ratchet type of drive with improved means for inhibiting uncalled-for rotation of the ratchet wheel and shaft; the provision of a tool with such means which is relatively self-compensating for wear, and which is relatively long-lived and does not require shimming or replacement often as the washer arrangement; and the provision of such means which is relatively readily and economically incorporated in the tool.

In general, a hand-held power tool of the invention comprises a housing having spaced front and back walls, with an output shaft mounted in the housing for rotation in one direction or the other on an axis extending transversely with respect to said walls. The shaft has an outer end portion projecting out from the front wall for reception of an attachment for the tool. A ratchet wheel on said shaft in the space between said walls is adapted to be driven in one direction or the other for rotating the shaft in the one direction or the other, said ratchet wheel having a side face facing a fixed surface on one of said walls and a plurality of recesses extending inward from said side face spaced at intervals around said axis, with a plurality of coil compression springs, one in each recess. A cylindrical pin is provided for each of said coil compression springs. Each cylindrical pin is engaged by a corresponding one of said coil compression springs for biasing the pin outward from the recess against said fixed surface for holding the ratchet wheel against rotation in a direction opposite the driven direction of rotation.

Other objects and features will be in part apparent and in part pointed out hereinafter.

### BRIEF DESCRIPTION OF THE DRAWINGS

FIG. 1 is a view in side elevation of a reversible-ratchet tool having means of this invention incorporated therein, broken away in part to show interior detail including said means;

FIG. 2 is an enlarged fragment of FIG. 1;

FIG. 3 is a view generally in section on line 3-3 of FIG. 2;

FIG. 4 is a view of the output shaft/ratchet wheel component per se;

FIG. 5 is a left side elevation of FIG. 4;

FIG. 6 is a right side elevation of FIG. 4; and

FIG. 7 is an enlarged side elevation of a cylindrical pin per se such as used in the tool.

Corresponding reference characters indicate corresponding parts throughout the several views of the drawings.

### DETAILED DESCRIPTION OF THE PREFERRED EMBODIMENT

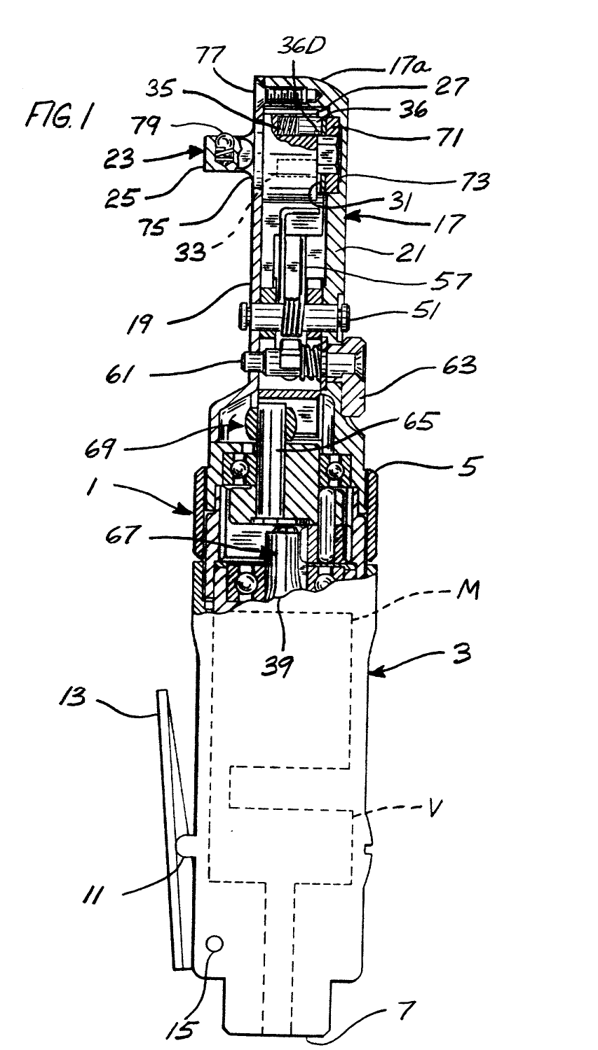

Referring to FIG. 1 of the drawings, a hand-held pneumatic power tool equipped with means of this invention for inhibiting uncalled-for rotation of the ratchet wheel (and output shaft) thereof, including the detrimental retrograde rotation above mentioned, is shown to comprise a generally elongate body sized and shaped to be held in the hand. The tool as a whole is designated 1, the elongate body is designated 3. The body has a forward end 5 and a rearward end 7 (“forward” and “rearward” as held in the hand). It is generally circular in transverse cross-section, having a motor chamber adjacent its forward end and a pneumatic motor M in the chamber, as is shown in said '646 patent and/or in said coassigned patent applications. The body is adapted at its rearward end 7 for connection of an air hose (not shown) for delivering air under pressure for operating the motor under control of a valve V in the body, the valve including stem II operable by lever 13 pivoted at 15. This connection may be as shown in said '646 patent or said coassigned patent applications.

Extending forward from body 3 is a housing generally designated 17 having spaced walls 19 and 21, the wall 19 being referred to as the front wall and the wall 21 being referred to as the back wall. At 23 is indicated an output shaft mounted in the housing adjacent the forward end 17a thereof for rotation in one direction or the other on an axis extending transversely with respect to the walls 19, 21. The shaft has an outer end portion 25 projecting out from the front wall for reception of an attachment for the tool. A spur gear constituting a ratchet wheel 27 is provided on the shaft in the space between walls 19, 21. The ratchet wheel is adapted to be driven in one direction or the other for rotating the output shaft 23 in the one direction or the other by the motor in the body 3 acting through a bidirectional ratchet drive mechanism of the type shown in the aforesaid '646 patent and coassigned patent applications.

The ratchet wheel 27 is preferably made integral with the shaft 23, having a side face 29 facing a fixed surface 31 on one of the walls 19, 21, namely the wall 21. In accordance with this invention, the ratchet wheel has a plurality of recesses each designated 33 extending inward from its said side face 29 spaced at intervals around its axis. These recesses hold a plurality of a coil compression springs, each designated 35, and partially contain a plurality of cylindrical pins 36, one spring and one pin in each recess. Each spring 35 is compressed between the inner end 37 of the respective recess and a shoulder 36A of the cylindrical pin 36. The cylindrical pin comprises a friction portion 36B and a locator portion 36C having a smaller diameter than the friction portion. The shoulder 36A is located at the intersection of the friction portion 36B and the locator portion 36C on a second end of the friction portion. The locator portion is received within the turns of the spring 35, effectively locating the spring on the pin 36. The friction portion 36B (on a first end thereof) frictionally engages said fixed surface 31 thereby acting in effect as braking means for inhibiting uncalled-for rotation of the ratchet wheel 27 and shaft 23, especially effective for inhibiting retrograde rotation thereof (in either direction). The cylindrical pins 36 each further include a detent 36D received through the friction portion 36B adjacent the periphery of the friction portion. The detent 36D engages the ratchet wheel 27 adjacent the corresponding recess 33 receiving the pin 36 to prevent the pin from being pushed fully into the recess. Thus, pin 36 is held in constant engagement with the fixed surface 31.

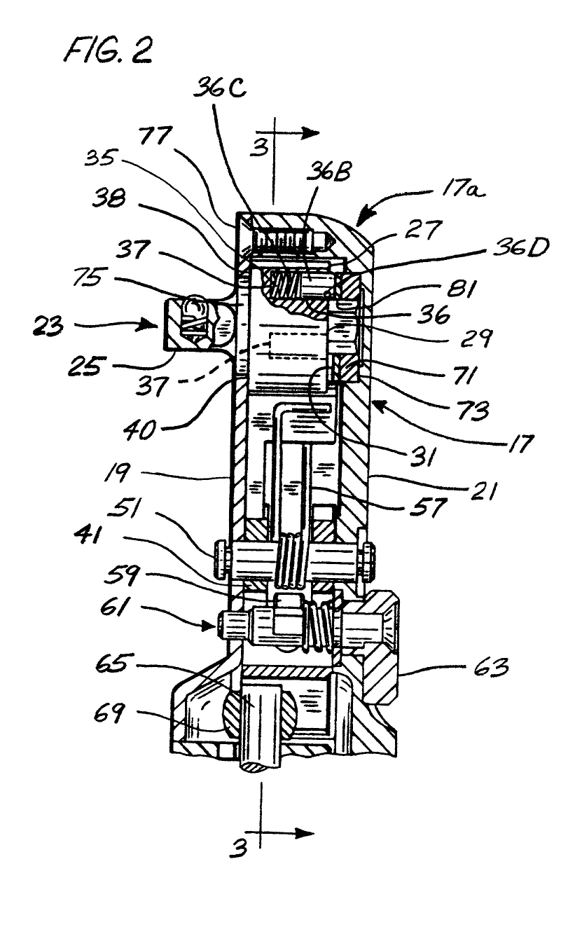

The ratchet wheel 27 has a side face 38 opposite its aforesaid face 29 facing and engaging the front wall 19. Thus, the ratchet wheel 27 (and shaft 23) are maintained against movement in the direction (toward the left as shown in FIGS. 1 and 2) toward the front wall under the bias of springs 35 and the compression of the springs is thereby maintained. Frictional engagement of side face 38 of the ratchet wheel with the front wall adds a braking effect.

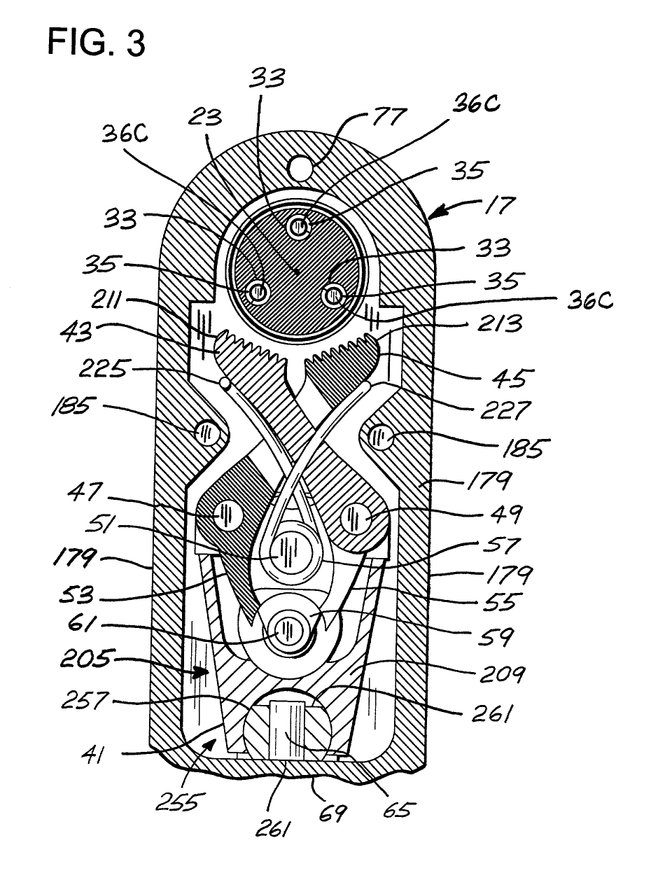

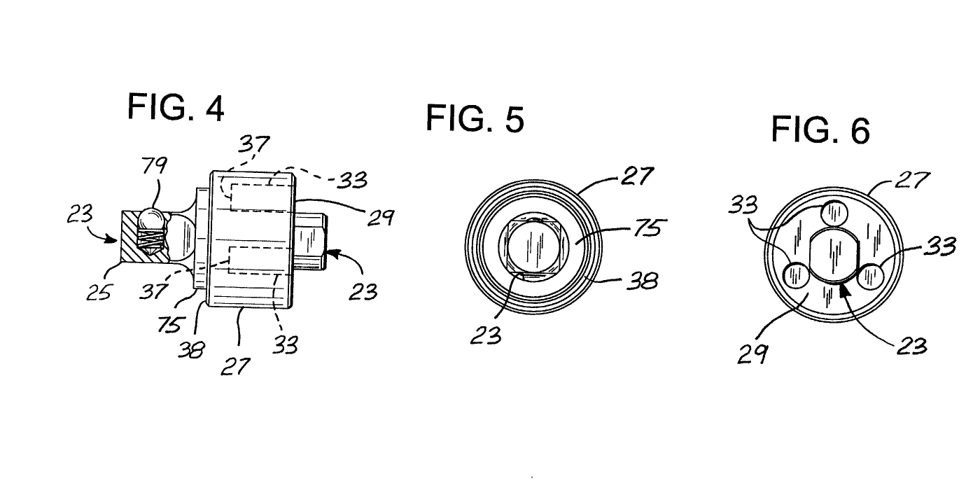

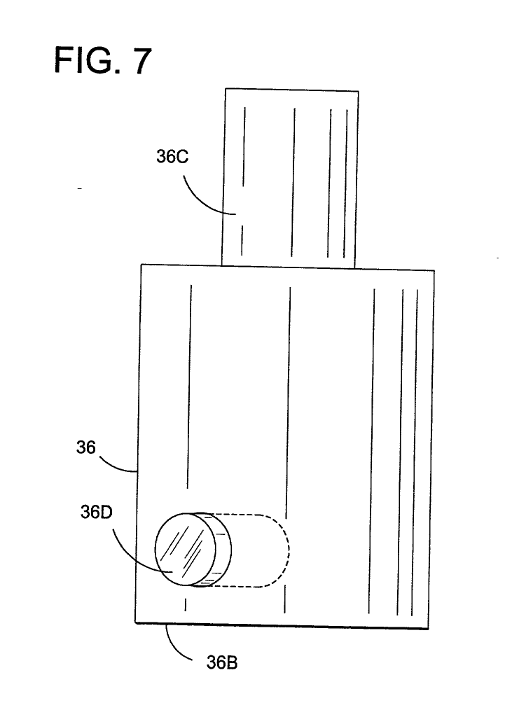

The bidirectional ratchet drive mechanism is powered by shaft 39 of the aforesaid pneumatic motor. This mechanism is generally of the same type as that disclosed in the aforesaid '646 U.S. patent and coassigned patent applications. For correlation therewith, there is shown herein pawl carrier 41 (“drive link” 16 of the '646 patent) having the pair of pawls 43 and 45 pivoted thereon at 47 and 49, respectively, and itself pivoted on a pin 51 for oscillation in housing 17 adjacent the rearward end thereof on an axis extending transversely of the housing. The pawls 43, 45 have the tails indicated at 53 and 55, respectively. Indicated at 57 is the spring for biasing the pawls for engagement of the tails with cam 59 on camshaft 61 operable by lever 63 between the position wherein pawl 43 is engageable with the ratchet wheel for driving it one way as viewed in FIG. 3 and the position wherein pawl 45 is engageable with the ratchet wheel for driving it the other way as viewed in FIG. 3. At 65 is indicated the crank driven via gearing indicated at 67 which effects oscillating action of pawl carrier 41 via link 69, oscillation of the pawl carrier effecting rotation of the ratchet wheel 27 and output shaft 23 in one direction or the other depending on the setting of lever 63.

The output shaft 23 is journalled at its end opposite the end 25 in an annular bearing 71 lodged in a circular recess 73 in the inside of wall 21 of housing 17. The ratchet wheel 27 has a disk formation 75 on its side opposite side 29 journalled in a circular opening in wall 19. The side face 38 of the ratchet wheel surrounds this disk formation. The wall 19 is removably mounted by means of screws such as indicated at 77. The outwardly projecting end 25 of shaft 23 (which is square) has a recess (not numbered) holding spring-backed ball detent 79 for application of the attachment (e.g. socket wrench attachment) for the tool. Bearing 71 has a wear-resistant facing 81, said surface 21 being the surface of this wear-resistant ring. Preferentially, three recess 33 and springs 35 are provided in the ratchet wheel 27, spaced around the axis thereof at 120° intervals.

Details of the motor M, valve V, passaging in the body 3 for flow and exhaust of air, and the bidirectional ratchet drive mechanism may be ascertained from the aforesaid '646 patent and coassigned patent applications which, as above noted, are incorporated herein by reference.

Wear of the pins 36 and/or the facing 81 is automatically compensated for by expansion of the springs 35, whereby the frictional braking effect of the springs is prolonged, without the shimming or washer replacement previously needed. The first ends of the pins 36 engaging the facing 81 are substantially flat so that the pins engage the facing over substantially the entire circular surface area of the first end, enhancing frictional braking. Moreover, the pins 36 may be made of a material and kind which is substantially the same hardness as the facing 81 to reduce wear of the pins. The relatively larger area of engagement of the first ends of the pins 36 with the facing 81 inhibits the pins cutting into the facing.

In view of the above, it will be seen that the several objects of the invention are achieved and other advantageous results attained.

As various changes could be made in the above constructions without departing from the scope of the invention, it is intended that all matter contained in the above description or shown in the accompanying drawings shall be interpreted as illustrative and not in a limiting sense.

What is claimed is:

1. A hand-held power tool comprising a housing having spaced front and back walls, an output shaft mounted in said housing for rotation in one direction or the other on an axis extending transversely with respect to said walls, said shaft having an outer end portion projecting out from the front wall for reception of an attachment for the tool, a ratchet wheel on said shaft in the space between said walls, said ratchet wheel being adapted to be driven in one direction or the other for rotating the shaft in the one direction or the other, said ratchet wheel having a side face facing a fixed surface on one of said walls and a plurality of recesses extending inward from said side face spaced at intervals around said axis, and a plurality of coil compression springs, one in each recess, a cylindrical pin for each of said coil compression springs, each cylindrical pin being engaged by a corresponding one of said coil compression springs for biasing the pin outward from the recess against said fixed surface for holding the ratchet wheel against rotation in a direction opposite the driven direction of rotation.

2. A hand-held power tool as set forth in claim 1 wherein each of said cylindrical pins is at least partially received in a corresponding one of said recesses in the ratchet wheel.

3. A hand-held power tool as set forth in claim 2 wherein each cylindrical pin comprises a friction portion having a first end engageable with the fixed surface and a locator stud disposed on a second end of the friction portion opposite the first end, the locator stud having a smaller transverse dimension than the friction portion and being received internally of said coil compression spring.

4. A hand-held power tool as set forth in claim 3 wherein the first end of the friction portion of the cylindrical pin is flat for engaging the fixed surface over substantially the entire circular surface area of the first end.

5. A hand-held power tool as set forth in claim 4 wherein said shaft is journalled in a bearing on said one wall and said surface is on said bearing.

6. A hand-held power tool as set forth in claim 5 wherein said surface is the surface of a wear-resistant flat ring on the bearing.

7. A hand-held power tool as set forth in claim 1 wherein said front wall is removable and said surface is on the back wall, said side of the ratchet facing the back wall.

8. A hand-held power tool as set forth in claim 7 wherein said shaft is journalled in a bearing on the back wall and said surface is on said bearing.

9. A hand-held power tool as set forth in claim 8 wherein said surface is the surface of a wear-resistant flat ring on the bearing.

10. A hand-held power tool as set forth in claim 1 wherein said ratchet wheel has an opposite side face facing and engaging the other wall.

11. A hand-held power tool as set forth in claim 10 wherein said surface is on the back wall, said opposite side face facing and engaging the front wall thereby maintaining the ratchet wheel and shaft from movement in the direction of the front wall under the bias of the springs.

12. A hand-held power tool as set forth in claim 1 having three recesses each containing one of said springs spaced at 120° intervals around the axis of the wheel.

13. A hand-held power tool as set forth in claim 1 wherein each cylindrical pin comprises a friction portion having a first end engageable with the fixed surface and a locator stud disposed on a second end of the friction portion opposite the first end, the locator stud having a smaller transverse dimension than the friction portion and being received internally of said coil compression spring.

14. A hand-held power tool as set forth in claim 1 wherein the first end of the friction portion of the cylindrical pin is flat for engaging the fixed surface over substantially the entire circular surface area of the first end.
